(19) United States
(12) Patent Application Publication
(10) Pub. No.: US 2015/0282011 A1
(43) Pub. Date: Oct. 1, 2015

(54) SYSTEMS AND/OR METHODS FOR IMPROVING PACKET-SWITCHED SERVICES DURING CIRCUIT SWITCHED FALLBACK (CSFB)

(71) Applicant: INTERDIGITAL PATENT HOLDINGS, INC., Wilmington, DE (US)

(72) Inventor: Mahmoud Watfa, Saint Leonard (CA)

(73) Assignee: INTERDIGITAL PATENT HOLDINGS, INC., Wilmington, DE (US)

(21) Appl. No.: 14/438,439

(22) PCT Filed: Oct. 25, 2013
(86) PCT No.: PCT/US2013/066824

§ 371 Date: Apr. 24, 2015

Related U.S. Application Data
(60) Provisional application No. 61/719,329, filed on Oct. 26, 2012.

(51) Int. Cl. H04W 36/00; H04W 28/08; H04W 36/30

(52) U.S. Cl. CPC H04W 36/0022; H04W 36/30; H04W 28/08; H04W 84/12

(57) ABSTRACT

Systems and/or methods for providing packet-switched (PS) services during a circuit-switched callback (CSFB) may be disclosed. For example, PS traffic may be offloaded over WiFi (e.g. from LTE) for CSFB during a CS call such that a PS session may be at least simultaneously maintained on WiFi during the CS voice call. The offloading may be stopped after an expiration of a timer.

### CROSS REFERENCE TO RELATED APPLICATIONS

This application claims the benefit of U.S. Provisional Patent Application No. 61/719,329, filed Oct. 26, 2012, the content of which is hereby incorporated by reference herein.

### BACKGROUND

Today, voice communications or calls using a device in wireless communication system may be obtained using a different techniques or domains including IP-based techniques or domains or circuit switched (CS)-based techniques domains. Currently, to initiate such voice communications or calls using the device, an inter-system change may be performed to switch the device to a domain or service such as a CS-based domain or service from, for example, a packet-switched (PS) service or session that may be used for data communications (e.g. from a PS domain such as long term evolution (LTE) to a CS domain such as UTRAN, GERAN, CDMA, and the like). Such an inter-system change may be realized with either a PS handover (HO) or without PS HO. In either case, the PS session on the device may be interrupted thereby leading to a negative impact on the experience of a user operating the device. For example, a user may actually call another person via his or her device to discuss an article, news event, or Internet posting. During the call, the user may wish to talk to the other person while reading directly from a web page that may include the article, news event, or Internet posting. Thus, even though the user may wish to discuss web contents in the call, the user may not be able to since the PS session may be suspended until after the CS call ends. As such, it may not be possible to have simultaneous PS and CS sessions. Additional techniques may be used to enable simultaneous PS and CS sessions after a successful PS HO (e.g. from LTE to UTRAN and/or or after redirection to UTRAN). Unfortunately, the PS session of the device may still be interrupted using such techniques and such an interruption may be high (e.g. if a Location Area Updating procedure or method may first be performed).

### SUMMARY

Systems and/or methods for providing and/or improving packet-switched (PS) services during circuit switched fallback (CSFB) may be disclosed. For example, during a CSFB to GERAN with no DTM or PS handover (PS HO) support in a network, a device may offload traffic for a PS session to a WiFi connection during a CS voice call over the network such that the PS session may be maintained on WiFi during the CS voice call over the network. In an example, the device may stop offloading the PS session on the WiFi connection after an expiration of a timer. Further, in an embodiment, at least a portion of the traffic for the PS session may offloaded to the WiFi connection after the CS voice call may end (e.g. if offloading may occur prior to the CS voice call). The device may also receive an indication to offload the traffic for the PS session to the WiFi connection. The indication may be in response to the CS voice call, an extended service request (ESR), a NAS message, and/or the like. In an example, the PS session may be offloaded to another network during the CS voice call (e.g. when signal strength with the WiFi may degrade below a threshold). Further, an active NAS context for the PS session may be maintained in the network during the offload.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

A more detailed understanding of the embodiments disclosed herein may be had from the following description, given by way of example in conjunction with the accompanying drawings.

FIG. 1A depicts a system diagram of an example communications system in which one or more disclosed embodiments may be implemented.

FIG. 1B depicts a system diagram of an example wireless transmit/receive unit (WTRU) that may be used within the communications system illustrated in FIG. 1A.

FIG. 1C depicts a system diagram of an example radio access network and an example core network that may be used within the communications system illustrated in FIG. 1A.

FIG. 1D depicts a system diagram of another example radio access network and another example core network that may be used within the communications system illustrated in FIG. 1A.

FIG. 1E depicts a system diagram of another example radio access network and another example core network that may be used within the communications system illustrated in FIG. 1A.

FIG. 2 illustrates an example embodiment of a CSFB with a PS HO.

FIG. 3 illustrates an example embodiment of a CSFB with a RRC connection release.

FIG. 4 illustrates an example embodiment of an eNB and WiFi interworking for traffic overload.

FIG. 5 illustrates an example embodiment of overlapping E-UTRAN and GERAN/UTRAN coverage.

FIG. 6 illustrates an example embodiment of a method or procedure for WiFi offloading during CSFB.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

Systems and/or methods for providing and/or improving packet-switched (PS) services during circuit-switched fallback (CSFB) (e.g. a UE, WTRU, or device) may be provided. In such systems and/or methods, WiFi may be offloaded due to CSFB (e.g. which may be referred to as ODC). For example, PS traffic may be offloaded over WiFi when CSFB may be performed. This may enable a device such as a UE and/or WTRU and/or a user (e.g. UE/user) to continue with an ongoing PS session without interruption. To make this possible and/or consequences thereof, one or more of the following (e.g. changes) may be provided and/or used. Subscription information (e.g. new subscription information) may be provided and/or used to state whether this service may be allowed for a user. Additionally, the device may be associated with an access point (AP) and/or may be indicated to the network (e.g. eNB and/or MME) that it may have associated with an identified AP when a CSFB request may be sent. This may defines a trigger (e.g. a new trigger) to associate with an AP and also to indicate to the network about the association. The UE may also the system if ODC may be used based on UE policies, user intervention, for example, per CSFB request, and/or one or more configurations that may indicate ODC for each AP and/or CSG with which the UE may be associated. A MME may also decide to perform ODC based on subscription information and/or UE indications. In such an embodiment, an indication and/or message (e.g. a new indication and/or message) may be provided and/or used to inform an eNB to perform ODC. Additionally (e.g. if done), the MME may maintain the UE's context as if the UE may be under E-UTRA and the MME may defer session management requests during ODC. Alternatively, the MME may accept network based session management requests, may inform the eNB & SGW to modify bearers, and/or may perform the corresponding NAS signaling with the UE after its return to LTE. The eNB may also broadcast the support of ODC. Moreover, the eNB may decide to perform ODC based on several triggers such as a MME indication, a UE/device indication, and/or knowledge of a lack of support of PS HO or DTM in the target system. Additionally, a command (e.g. a new command) from the eNB to the UE that may indicate use of ODC and also a S1AP message (e.g. a new S1AP message) to the MME to indicate ODC may be active may be provided and/or used. In such an embodiment, this may trigger the MME to consider the UE being in a EMM-CONNECTED mode. Even though the device may be accessing the CS domain, it may still maintain its LTE/RRC configurations and may receive and/or transmit data over the Wifi AP. If the signal strength may start degrading, the device may access the PS domain in GERAN/UTRAN and may indicate ODC may have been active to the SGSN. This may trigger the SGSN to resume the PS session over GERAN/UTRAN. The SGSN may further the MME that may use a S1AP message (e.g. a new S1AP message) to inform the eNB to stop ODC.

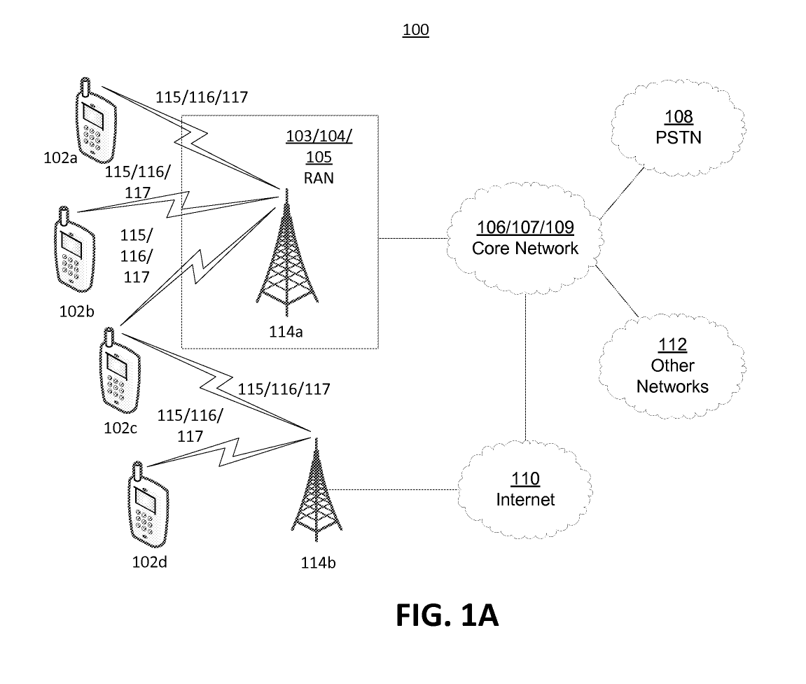

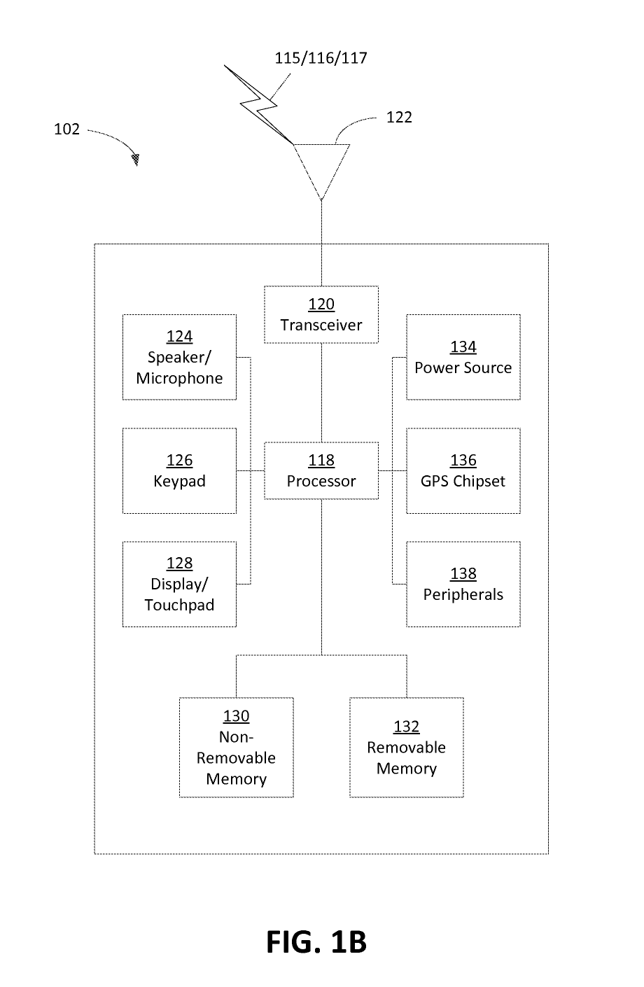

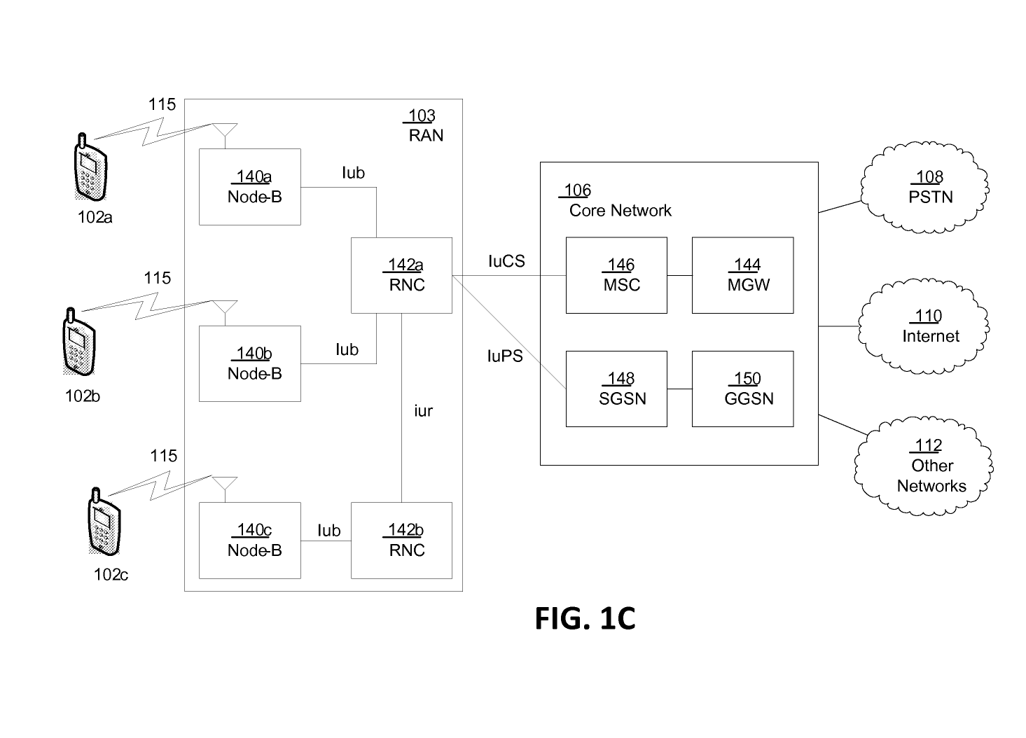

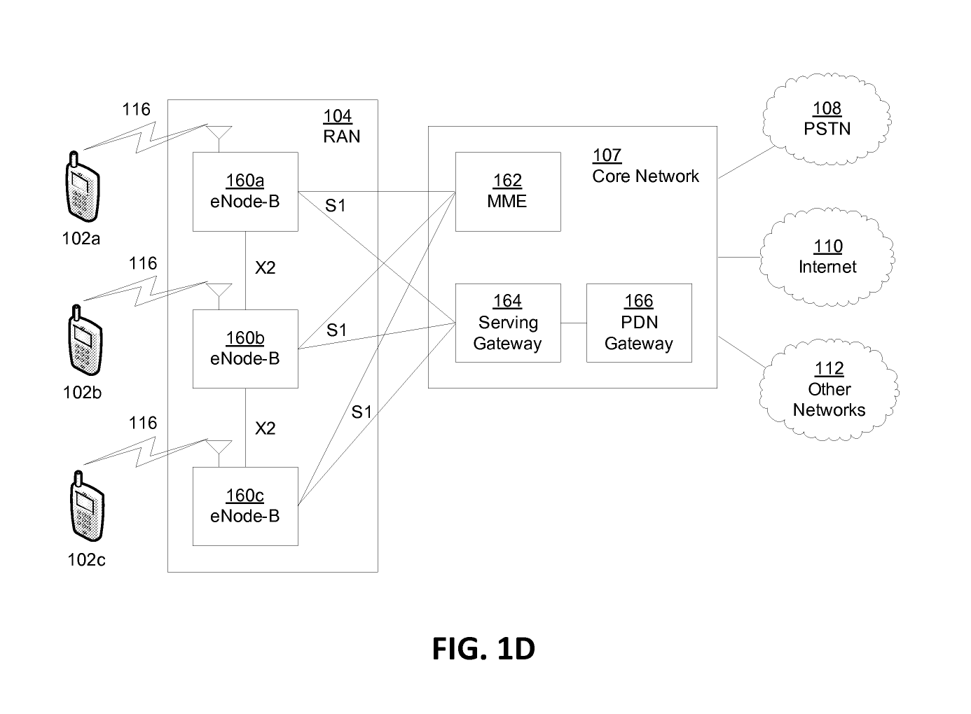

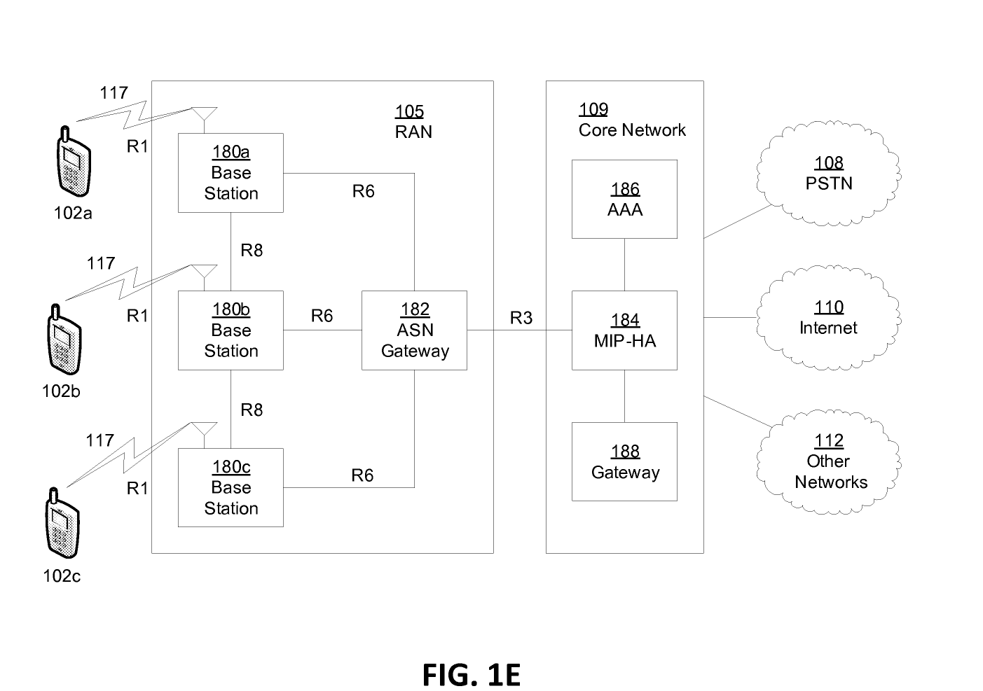

FIG. 1A depicts a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, and/or 102d may be any type of device configured to operate and/or communicate in a wireless environment. By way of example, the WTRUs 102a, 102b, 102c, and/or 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, and/or 102d to facilitate access to one or more communication networks, such as the core network 106/107/109, the Internet 110, and/or the networks 112. By way of example, the base stations 114a and/or 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a and/or 114b may communicate with one or more of the WTRUs 102a, 102b, 102c, and/or 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, and/or 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, and/or 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, and/or 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, and/or 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, and/or 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, and/or 102d in the communications system 100 may include multi-mode capabilities, i.e., the WTRUs 102a, 102b, 102c, and/or 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B depicts a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it may be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C depicts a system diagram of the RAN 103 and the core network 106 according to an embodiment. As noted above, the RAN 103 may employ a UTRA radio technology to communicate with the WTRUs 102a, 102b, and/or 102c over the air interface 115. The RAN 103 may also be in communication with the core network 106. As shown in FIG. 1C, the RAN 103 may include Node-Bs 140a, 140b, and/or 140c, which may each include one or more transceivers for communicating with the WTRUs 102a, 102b, and/or 102c over the air interface 115. The Node-Bs 140a, 140b, and/or 140c may each be associated with a particular cell (not shown) within the RAN 103. The RAN 103 may also include RNCs 142a and/or 142b. It will be appreciated that the RAN 103 may include any number of Node-Bs and RNCs while remaining consistent with an embodiment.

As shown in FIG. 1C, the Node-Bs 140a and/or 140b may be in communication with the RNC 142a. Additionally, the Node-B 140c may be in communication with the RNC142b. The Node-Bs 140a, 140b, and/or 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, and/or 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and/or 102c with access to circuit-switched networks, such as the PSTN 108, to facilitate communications between the WTRUs 102a, 102b, and/or 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and/or 102c with access to packet-switched networks, such as the Internet 110, to facilitate communications between and the WTRUs 102a, 102b, and/or 102c and IP-enabled devices.

As noted above, the core network 106 may also be connected to the networks 112, which may include other wired or wireless networks that are owned and/or operated by other service providers.

FIG. 1D depicts a system diagram of the RAN 104 and the core network 107 according to an embodiment. As noted above, the RAN 104 may employ an E-UTRA radio technology to communicate with the WTRUs 102a, 102b, and/or 102c over the air interface 116. The RAN 104 may also be in communication with the core network 107.

The RAN 104 may include eNode-Bs 160a, 160b, and/or 160c, though it will be appreciated that the RAN 104 may include any number of eNode-Bs while remaining consistent with an embodiment. The eNode-Bs 160a, 160b, and/or 160c may each include one or more transceivers for communicating with the WTRUs 102a, 102b, and/or 102c over the air interface 116. In one embodiment, the eNode-Bs 160a, 160b, and/or 160c may implement MIMO technology. Thus, the eNode-B 160a, for example, may use multiple antennas to transmit wireless signals to, and receive wireless signals from, the WTRU 102a.

Each of the eNode-Bs 160a, 160b, and/or 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, and/or 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and/or 160c in the RAN 104 via an S1 interface and may serve as a control node. For example, the MME 162 may be responsible for authenticating users of the WTRUs 102a, 102b, and/or 102c, bearer activation/deactivation, selecting a particular serving gateway during an initial attach of the WTRUs 102a, 102b, and/or 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and/or 160c in the RAN 104 via the S1 interface. The serving gateway 164 may generally route and forward user data packets to/from the WTRUs 102a, 102b, and/or 102c. The serving gateway 164 may also perform other functions, such as anchoring user planes during inter-eNode B handovers, triggering paging when downlink data is available for the WTRUs 102a, 102b, and/or 102c, managing and storing contexts of the WTRUs 102a, 102b, and/or 102c, and the like.

The serving gateway 164 may also be connected to the PDN gateway 166, which may provide the WTRUs 102a, 102b, and/or 102c with access to packet-switched networks, such as the Internet 110, to facilitate communications between the WTRUs 102a, 102b, and/or 102c and IP-enabled devices.

The core network 107 may facilitate communications with other networks. For example, the core network 107 may provide the WTRUs 102a, 102b, and/or 102c with access to circuit-switched networks, such as the PSTN 108, to facilitate communications between the WTRUs 102a, 102b, and/or 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, and/or 102c with access to the networks 112, which may include other wired or wireless networks that are owned and/or operated by other service providers.

FIG. 1E depicts a system diagram of the RAN 105 and the core network 109 according to an embodiment. The RAN 105 may be an access service network (ASN) that employs IEEE 802.16 radio technology to communicate with the WTRUs 102a, 102b, and/or 102c over the air interface 117. As will be further discussed below, the communication links between the different functional entities of the WTRUs 102a, 102b, and/or 102c, the RAN 105, and the core network 109 may be defined as reference points.

As shown in FIG. 1E, the RAN 105 may include base stations 180a, 180b, and/or 180c, and an ASN gateway 182, though it will be appreciated that the RAN 105 may include any number of base stations and ASN gateways while remaining consistent with an embodiment. The base stations 180a, 180b, and/or 180c may each be associated with a particular cell (not shown) in the RAN 105 and may each include one or more transceivers for communicating with the WTRUs 102a, 102b, and/or 102c over the air interface 117. In one embodiment, the base stations 180a, 180b, and/or 180c may implement MIMO technology. Thus, the base station 180a, for example, may use multiple antennas to transmit wireless signals to, and receive wireless signals from, the WTRU 102a. The base stations 180a, 180b, and/or 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, and/or 102c and the RAN 105 may be defined as an R1 reference point that implements the IEEE 802.16 specification. In addition, each of the WTRUs 102a, 102b, and/or 102c may establish a logical interface (not shown) with the core network 109. The logical interface between the WTRUs 102a, 102b, and/or 102c and the core network 109 may be defined as an R2 reference point, which may be used for authentication, authorization, IP host configuration management, and/or mobility management.

The communication link between each of the base stations 180a, 180b, and/or 180c may be defined as an R8 reference point that includes protocols for facilitating WTRU handovers and the transfer of data between base stations. The communication link between the base stations 180a, 180b, and/or 180c and the ASN gateway 182 may be defined as an R6 reference point. The R6 reference point may include protocols for facilitating mobility management based on mobility events associated with each of the WTRUs 102a, 102b, and/or 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and/or 102c to roam between different ASNs and/or different core networks. The MIP-HA 184 may provide the WTRUs 102a, 102b, and/or 102c with access to packet-switched networks, such as the Internet 110, to facilitate communications between the WTRUs 102a, 102b, and/or 102c and IP-enabled devices. The AAA server 186 may be responsible for user authentication and for supporting user services. The gateway 188 may facilitate interworking with other networks. For example, the gateway 188 may provide the WTRUs 102a, 102b, and/or 102c with access to circuit-switched networks, such as the PSTN 108, to facilitate communications between the WTRUs 102a, 102b, and/or 102c and traditional land-line communications devices. In addition, the gateway 188 may provide the WTRUs 102a, 102b, and/or 102c with access to the networks 112, which may include other wired or wireless networks that are owned and/or operated by other service providers.

Although not shown in FIG. 1E, it should, may, and/or will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, and/or 102c between the RAN 105 and the other ASNs. The communication link between the core network 109 and the other core networks may be defined as an R5 reference, which may include protocols for facilitating interworking between home core networks and visited core networks.

As described herein, systems and/or methods to obtain voice calls in a communication system including LTE may be provided and/or used. For example, IP-based techniques, methods, or solutions and/or CS-based techniques, methods, or solutions may be used to obtain voice calls in a communication system including LTE may be provided and/or used. IP-based techniques, methods, or solutions may include voice services that may be provided over Internet Protocols (IP) using, for example, an IP multimedia subsystem (IMS), Voice over LTE via Generic Access (Volga), third party applications such as Skype, and/or the like. Additionally, CS-based techniques, methods, or solutions may be used such that a device such as a UE or WTRU (e.g. WTRU 102a-d shown in FIGS. 1A-1E) may use and/or request the system to move it to the CS domain where it may actually receive a voice service. This method may be circuit-switched fallback (CSFB).

In CSFB, a device such as a WTRU or UE may perform a combined registration to a PS domain (e.g. in LTE) and a CS domain (e.g. in a MSC and/or VLR), for example, while the device may be in E-UTRAN. In an embodiment, this may be performed by setting an attach type to a particular value in an attach request message. For example, a value may be included and/or sent to indicate, for example, a “combined EPS/IMSI attach” in the attach request message. The device may perform CSFB, for example, in response to a mobile originated (MO) call that may be placed by the user and/or in response to a mobile terminated (MT) call that may be triggered by the MSC and/or VLR, which may cause the LTE system (e.g. the MME) to inform the device about the MT request. In an example, the CSFBS may perform CSFB when the device may be combined registered.

According to an embodiment, an MO CSFB may be initiated from either an idle or connected mode. In either mode, the device may send a NAS message. The NAS message may be an Extended Service Request (SR).

Further, a MT CSFB request may arrive when the device may be either in idle or connected mode. If the device may be in an idle mode, the MME may page the device. A RRC Paging message may indicate, for example, that the core network that may have initiated the page may be the CS domain. In such an example, the device may know that this may be a MT CSFB request. If the device may be in the connected mode, the MME may send a NAS message such as a CS Service Notification to the device. In these examples, the device may respond (e.g. again) with the ESR message to the MME.

The device may also register to the CS Domain as described herein. For example, an interface such as a “SGs” interface may be defined between the MME and the MSC/VLR. This interface may be used for one or more procedures or methods (e.g. as described herein). For example, the SGs interface may be used in MME initiated procedure to register the device at the MSC and/or VLR.

When the MME may receive a combined registration for the PS and CS domain from the device, the MME may initiate a procedure or method on the SGs interface to register the device in the MSC and/or VLR. The VLR, in an example, may respond to the MME with the result of the registration, and optionally some identification that may be passed to the device for CS related procedures such as Location Area Identification (LAI), TMSI, and/or any other suitable identification. The MME may respond to the device with the attach result (e.g. the attach result message). In an example, the MME may indicate if the attach request may have been successful for both the PS and the CS domain. The device may request a MO CSFB and/or may receive a MT CSFB (e.g. in response to or if the attach result may have been successful).

According to an example embodiment, a MT CS call may be received at the MSC/VLR that may then use the SGs interface to request the MME to page the device for a MT CSFB request. The MME may page the device or send a dedicated NAS message if the device may be in idle mode or connected mode, respectively (e.g. as described above).

In examples, a device may perform inter-system change from LTE to GERAN/UTRAN. For example, as described herein, CSFB may include one or more actions that may be performed (e.g. in a method or procedure). For example, CSFB may include moving (e.g. RAT switching) the device to the CS domain (e.g. an inter-system change), setting up an actual voice call and performing or providing data exchange that may be conducted over the CS domain (e.g. UTRAN, GERAN, CDMA, and/or the like), and/or the like. Examples described herein may describe moving the UE to the CS domain and/or the functionality of inter-system change.

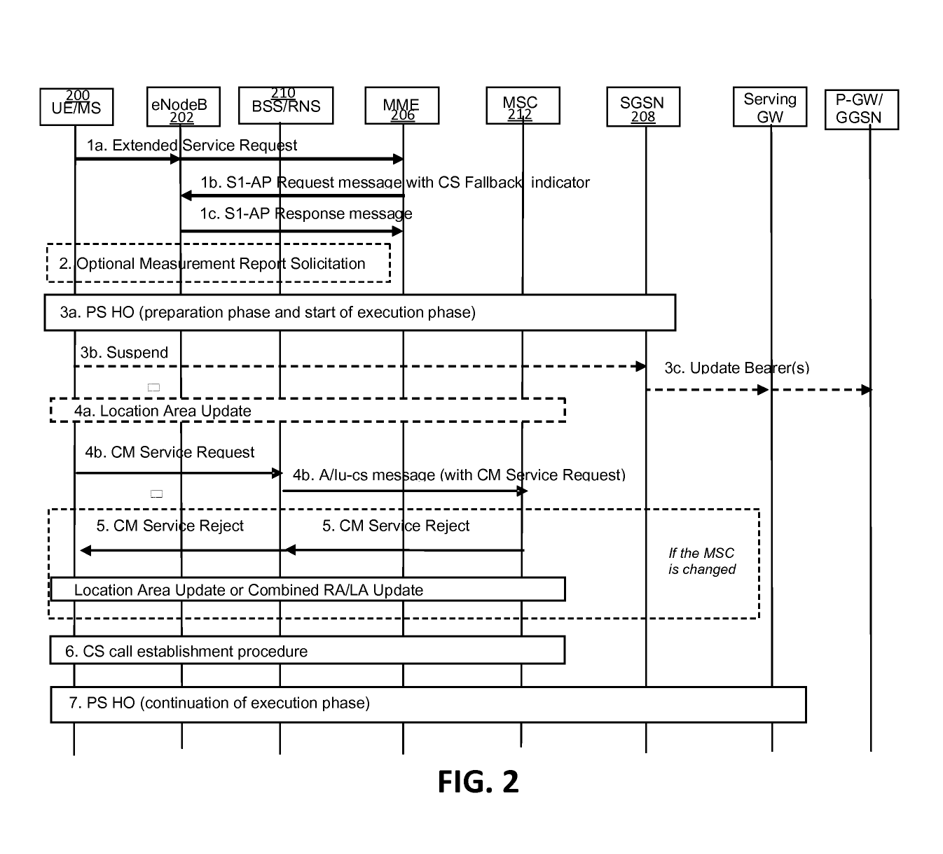

According to an example, the inter-system change may be triggered , for example, when the device may send an extended service request (ESR) message to the MME. This may apply to both MO and MT requests, for example, for either MO or MT calls when the device may send the ESR message to the MME. The inter-system changed may be realized using one or more of the following options. For example, in an example (e.g. a first option), the inter-system change may be executed via a PS handover (HO) procedure where the device's PS session may handed over to UTRAN or GERAN (e.g. if PS HO may be supported). Even though the device may change systems using a PS HO, the device may establish a voice call before continuing its PS service. This may be shown in FIG. 2.

For example, FIG. 2 illustrates an example CSFB with a PS HO. As shown in FIG. 2, at 1a-1c, a device 200 (e.g. a UE or WTRU such as the WTRU 102a-d described in FIGS. 1A-1E) may trigger an inter-system change. For example, at 1a, the device 200 may send an ESR to an eNodeB 202. The eNodeB 202 may be the same or similar to the example eNode-B 160a-160d described in FIG. 1D. The eNB 202 may forward or send the ESR onto a MME 204 to indicate to the MME to perform CS fallback. The MME 204 may be the same or similar to the example MME 162 described in FIG. 1D. The MME 204 may respond with an S1-AP request message at 1b. The S1-AP request message may include a CS fallback indicator that may include a value or other indicator that may signal to the eNodeB 202 to perform the CS fallback (e.g. because the device 200 may be initiating and/or receiving a voice call). For example, the S1-AP request message may indicate to the eNodeB 202 that the device 202 should be moved (e.g. to UTRAN/GERAN). As shown, the eNodeB 202 may respond with a S1-AP response message to the MME 204 that may provide a context modification at 1c.

In an example, at 2, measurements may be optionally solicited. For example, at 2, the eNodeB 204 and/or other components such as the MME 204 may solicit one or more measurements form the device 200. In an example, the one or more measurements may be used to determine a target cell (e.g. the best GERAN/UTRAN cell) to which to handover to or to which a PS handover may be performed.

At 3a-c, the PS HO may be initiated and/or triggered. For example, at 3a, a preparation procedure or phase of a PS HO may be performed. Further, at 3a, an execution phase or procedure may be imitated or started. For example, as described herein, the device 200 may be handed over from a first radio access technology (RAT) such as LTE to another or second RAT such as GERAN/UTRAN. At 3a, the eNodeB 202 may indicate, signal, and/or send to a source and/or target cell (e.g. and/or the MME 206, device 200, and/or the like) that the PS HO may have been triggered as a result of CSFB and/or whether the CSFB may have been due to an emergency (e.g. as part of the preparation phase). The device 200 may receive and/or initiate a HO (e.g. in response to a command) and may attempt to connect to the target cell (e.g. as part of the execution phase). In an example, the HO or the message that may signal the HO may include the CS fallback indicator that may indicate to the device 200 that the HO may be result of a CSFB. The device 200 may further establish a radio signaling connection. At 3b, the device 200 may start a suspend procedure to suspend itself or place itself in a suspended status for PS during the voice call, for example, by sending a suspend message to a SGSN 208. The SGSN 208 may receive the suspend message and/or may perform the suspend procedure at 3c. For example, at 3c, the SGSN 208 may store the suspended status of the device and/or may preserve and/or suspend bearers (e.g. towards a serving GW and/or a P-GW/GGSN as shown).

As shown in FIG. 2, the device 200 (e.g. after accessing the CS domain) may start and/or perform CS related procedures and/or methods (e.g. at 4a-6) and may then continue with the PS session. For example, the device 200 may initiate a location area update and/or a combined routing area (RA)/location area (LA) update procedure at 4a (e.g. if the location of the target cell may be different than the source cell) at 4a and/or the device 200 may send a CM request to a BSS/RNS 210 at 4b such that the BSS/RNS 210 may forward the message (e.g. by itself or encapsulated within another message) to a MSC 212 at 4c. At 5, the MSC may respond with a CM service rejection message that may be sent to the BSS/RNS 210 and onto the device 200, for example, if the device 200 may not be registered with the MSC 212 such that the device 200 may perform and/or imitate the location area update procedure. The device 200 may establish the CS or voice call at 6. For example, the device 200 may initiate a CS call establishment procedure or method.

At 7, the continuation of the execution phase of the PS HO may be performed such that the PS session that may be interrupted before 7 may be completed. For example, other procedures or methods (e.g. actions) may be performed for the PS HO.

In an example, the interruption may be higher if 4a may be performed since it may include or involve performing a location area update with a MSC 212. Such an example may typically consume time. Thus, an application that may be using the PS domain may suffer degradation in service as the PS session may be halted for some time.

Further, the PS session may suffer service degradation when the device 200 may suspend (e.g. at 3b) the PS session in the target cell after the device may enter dedicated mode, and the device or the network may not support a Dual Transfer Mode (DTM). In an example (e.g. if suspended), the PS session may be resumed after the device's CS service (e.g. CS call) may terminate, for example, at 7 in FIG. 2. As such, in examples, the PS session may be interrupted and the interruption may be worse if the device 200 may perform a location area update and/or if the device 200 or the network may not support DTM.

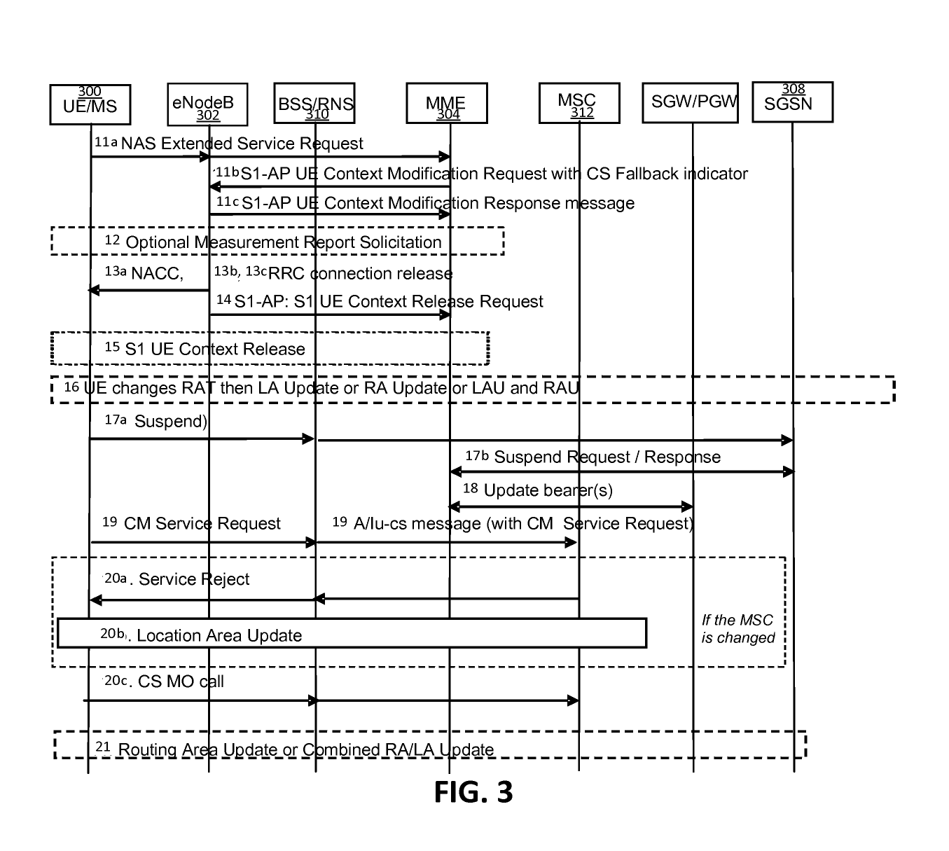

In an additional or alternative example, the inter-system change may be executed via a RRC connection release and/or redirection to UTRAN or GERAN cell. For example, an eNodeB may decide, using implementation methods, whether or not the CSFB may be performed with PS HO or without PS HO. In an example, to perform CSFB without a PS HO, the eNode by may use a RRC connection release and/or redirection as described herein. This may be shown in FIG. 3.

For example, FIG. 3 shows an example embodiment of moving a device 300 to another system without the use of PS HO (e.g. using a RRC release with redirection). As shown in FIG. 3, at 11a-11c, a device 300 (e.g. a UE or WTRU such as the WTRU 102a-d described in FIGS. 1A-1E) may trigger an inter-system change. For example, at 11a, the device 200 may send an ESR to an eNodeB 302. The eNodeB 302 may be the same or similar to the example eNode-B 160a-160d described in FIG. 1D. The eNodeB 302 may forward or send the ESR onto a MME 304 to indicate to the MME to perform CS fallback. The MME 304 may be the same or similar to the example MME 162 described in FIG. 1D. The MME 304 may respond with an S1-AP request message at 11b. The S1-AP context modification request message may include a CS fallback indicator that may include a value or other indicator that may signal to the eNodeB 302 to perform the CS fallback (e.g. because the device 300 may be initiating and/or receiving a voice call). For example, the S1-AP context modification request message may indicate to the eNodeB 302 that the device 300 should be moved (e.g. to UTRAN/GERAN). As shown, the eNodeB 302 may respond with a S1-AP context modification response message to the MME 304 that may provide a context modification at 11c.

In an example, at 12, measurements may be optionally solicited. For example, at 12, the eNodeB 302 and/or other components such as the MME 304 may solicit one or more measurements form the device 300. In an example, the one or more measurements may be used to determine a target cell (e.g. the best GERAN/UTRAN cell) to which to handover to or to which a PS handover may be performed.

In an example, one or more of 13a, 13b, and/or 13c may be performed. For example, at 3a, the device 200 may receive a Network Assisted Cell Change (NACC) order that may redirect the device 300 to a GERAN cell. Additionally or alternatively, 13b and/or 13c may be performed. For example, the eNodeB 302 may trigger a RRC connection release with a redirection, for example, to GERAN and/or UTRAN at 13b. The eNodeB 302 may trigger a RRC connection release with a redirection, for example, to GERAN and/or UTRAN and may include one or more physical cell identities and/or their associated system information. As such, 13b and/or 13c may involve the release of the device's RRC connection and the inclusion of redirection information (e.g. where 13c may differ from 13b due to the inclusion of multi cell system information in the release message). In an example, whether or not NACC order or release with redirection may be used, the PS HO may not be supported and this may interrupt ongoing PS sessions.

At 14, the eNodeB 302 may send an S1-AP context release request message to the MME 304. Such a message may include an indication on whether the device 300 may be available for a PS service or session in one or more examples. At 15, the MME 304 may release the device context in the eNodeB 302 as well as eNodeB related information in a S-GW. In an example, the MME 304 may suspend bearers (e.g. as described at 8), for example, if RRC may have been released due to abnormal conditions such as a radio link failure (RLF).

In an example, at 16, the device 302 may change the RAT (e.g. may switch from the source to target cell and/or may establish a radio signaling connection). Further, the device 302 may perform a LA update, RA update, LAU, RAU, and/or the like.

At 17a, the device 300 may start a suspend procedure to suspend itself or place itself in a suspended status for PS during the voice call, for example, by sending a suspend message to a BSS/RNS 306 that may be forwarded to a SGSN 308. The SGSN 308 may receive the suspend message, may perform the suspend procedure , may send a suspend request to the MME 304, and/or may receive a suspend response at 17b. At 18, the MME 304 may preserve and/or suspend bearers (e.g. towards a serving GW and/or a P-GW/GGSN as shown) based on the S1-AP context release request message at 14 (e.g. rather than the suspend procedure as described in FIG. 2).

The device 300 may continue setting up a MO call by sending a CM service request at 19. For example, the device 300 may send a CM request to a BSS/RNS 310 at 19 such that the BSS/RNS 310 may forward the message (e.g. by itself or encapsulated within another message) to a MSC 312. At 20a, the MSC 312 may respond with a CM service rejection message that may be sent to the BSS/RNS 310 and onto the device 300, for example, if the device 300 may not be registered with the MSC 312 such that the device 300 may perform and/or initiate the location area update procedure at 20b. The device 300 may establish the CS MO voice call at 20c. For example, the device 300 may initiate a CS call establishment procedure or method.

At 21, the device 300 may resume PS services (e.g. after the CS call may be terminated and/or if the PS services may be suspended and the device 300 may be in a particular RAT). Additionally, according to an example, the network may support PS HO, but the LTE system may still choose to implement inter-system change using a RRC connection release with redirection. For example, this may be performed when the CSFB request (e.g. via ESR) in LTE may indicate the use of CSFB for emergency calls.

In 3GPP, WiFi may be used to offload the LTE system from user plane traffic. For example, an eNB may have collocated a WiFi access point (AP) such that the eNB may dynamically or semi-statically send data over the LTE air interface and over the WiFi AP air interface. As such, the LTE user plane traffic may be partially or totally offloaded on WiFi. In an example, the offload method, for example, the protocol layer such as PDCP, RLC, and the like at which offload may occur or the rules and policies that may govern the offload may vary in different examples.

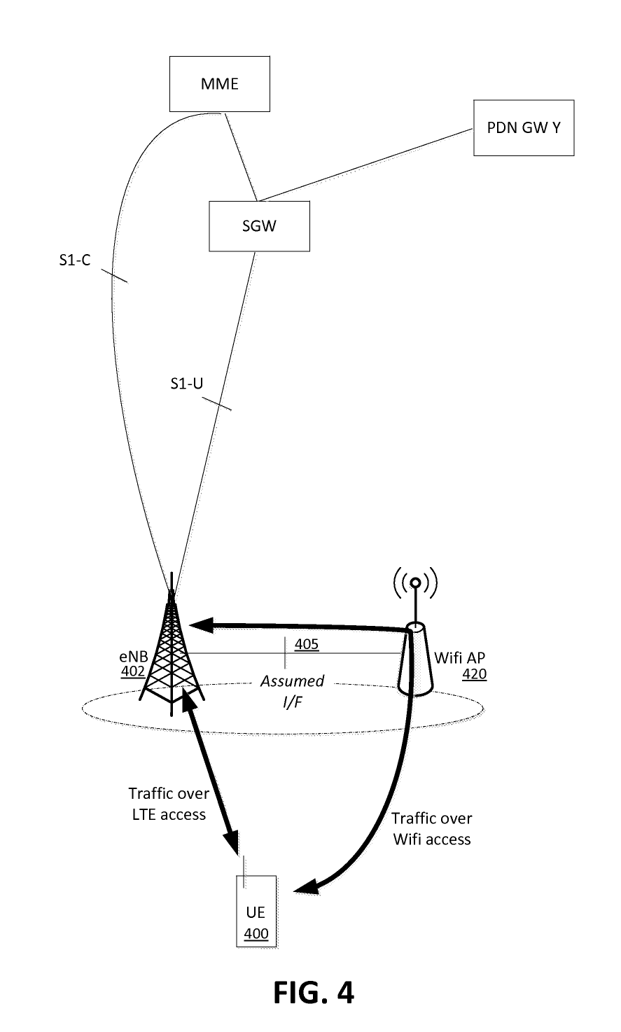

FIG. 4 shows an example method by which offload over Wifi may be used. As shown in FIG. 4, a WiFi AP 420 may be connected to an eNB 402 (e.g. may be collocated), for example, via an interface 401 such that the eNB 402 may be able to offload traffic such as at least a portion of download traffic over WiFi using the WiFi AP 400. For example, a device 400 may be connected to the WiFi AP 420 and the eNB 402. The eNB may be aware that the device 400 may be connected to the WiFi AP 420. The eNB 402 may choose to offload, for example, at least a portion of downlink traffic over the WiFi AP 420 such that the device 400 may receive data from the eNB 402 and the AP 420 simultaneously. Similarly, in the uplink, the device 400 may be configured to transmit some data over an LTE air interface 403 and other data over the WiFi air interface 405. In an example, the AP 420 may forward to the eNB 402 data that may be received from the device 400 via the interface 401 that may connect the eNB 402 and the AP 420.

Examples herein may use this functionality (e.g. Wifi offload) to enhance user experience related to CSFB, for example, to enhance the user experience when inter-system change may be performed and the user's PS session may be interrupted. For example, as described herein, an inter-system change may be realized with either PS HO or without PS HO. In the inter-system change, a user's PS session (e.g. the PS session of device associated with a user) may be interrupted in response to or due to at least one of the following. For example, a device may access the target system and may perform a location area update as described herein (e.g. at 4a in FIGS. 2 and 10b in FIG. 3) due to or in response to a change in the location area identity that may be allowed and/or enabled for the device (e.g. when the device may not be registered with a MSC). Additionally, the device and/or the target system may not support DTM such that the user's PS session may be suspended until the CS call may terminate. According to an example, the CS call may take minutes before completion so that the PS call may remain suspended for a longer period of time.

In an example (e.g. if a PS HO may not be supported), the device may take a longer time to access the target cell as compared to accessing a cell during a HO. For example, with a HO, a target cell may have been chosen for the device and the source cell may also provide a dedicate preamble that may be used by the device to access the target cell such that the device may access the target cell quicker than without the HO. However, for release with redirection, even though the device may be given some information, the device may still scan and select a cell. The device may then use the provided information (e.g. if the selected cell may have corresponding information) to the RRC release message that may have been received by the device, for example, in LTE.

A system such as an LTE system (e.g. the communication system shown in FIGS. 1A and 1C-1E) may realize and/or provide an inter-system change by releasing the device's connection and redirecting it to GERAN and/or UTRAN. When this may happen, the device's PS session in LTE may be interrupted until the device accesses the PS domain of, for example, GERAN and/or UTRAN. In an embodiment, this may happen after CS domain procedures for a voice call may be initiated.

In the examples described herein, there may be a negative impact on the user's experience with the interruption of the PS session. For example, a user may actually call another person to discuss an article, a news event, and/or an Internet posting. The user may wish to read directly from the website that may provide the content while talking to the other person. In some of the examples herein, even though the user may wish to discuss web contents in the call, the user may not be able to since, for example, the PS session may be suspended until after the CS call ends. As such, it may not be possible to have simultaneous PS and CS sessions. In other embodiments, there may be simultaneous PS and CS session, for example, after a successful PS handover from LTE to UTRAN or after redirection to UTRAN. However, device's PS session may still be interrupted and the interruption may be higher if a Location Area Updating procedure may be performed.

Systems and/or methods may be described herein may be provided and/or used to perform CSFB while maintaining an LTE PS session active via the use of WiFi offload. For example, using a WiFi AP, simultaneous PS and CS sessions may be maintained such that the user may be able to access a web page while simultaneously initiating or being in a CS voice call.

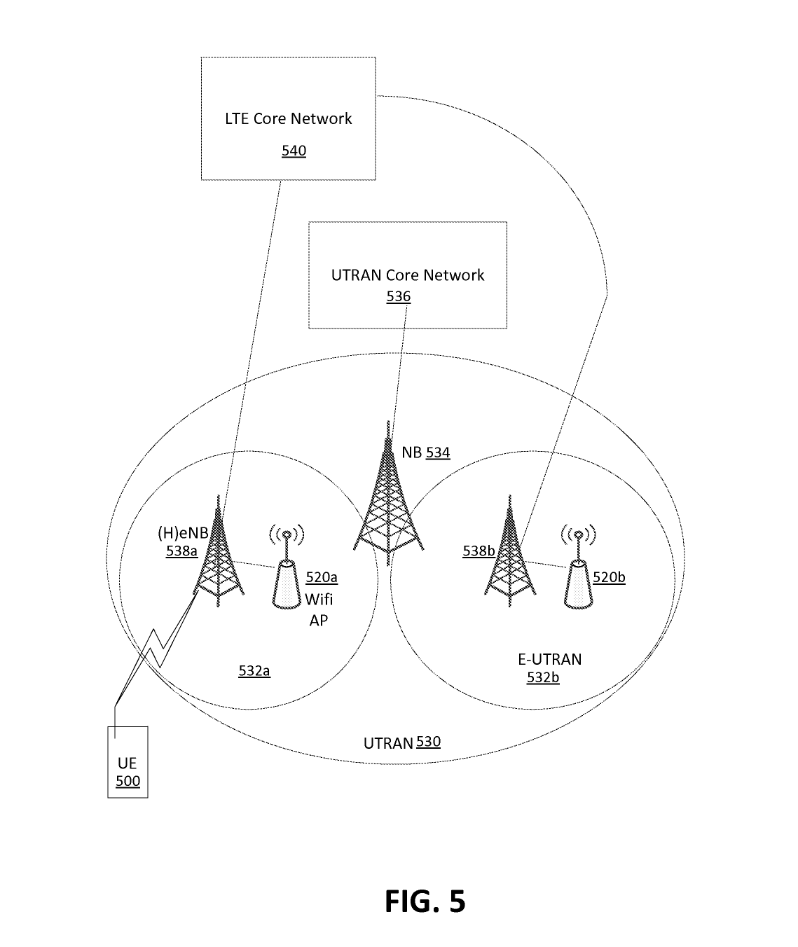

FIG. 5 shows an example network deployment that may include or provide E-UTRAN and UTRAN coverage. Although not shown in FIG. 5, an operator may provide E-UTRAN and GERAN coverage. As such, examples explained or proposed for the E-UTRAN and UTRAN coverage overlap may also apply to E-UTRAN and GERAN coverage overlap. In an example, UTRAN may be used as an example of a primary CS domain radio access technology (RAT) that may be used although other RATs may also be used (e.g. the embodiments herein may not be limited to the applicability to this RAT) such that the examples herein may be applied to both UTRAN and GERAN.

In an example, there may be overlapping E-UTRAN and UTRAN/GERAN coverage. For example, as shown in FIG. 5, a UTRAN coverage 530 may overlap one or more E-UTRAN coverage areas 532a, 532b. The UTRAN coverage area 530 may include a nodeB (NB) 534 or base station that may be associated with or a component of a UTRAN core network 536 (e.g. that may be similar or the same and/or may include one or more components of one of the core networks 103/104/105 shown in FIGS. 1A and 1C-1E). Further, as shown, the E-UTRAN coverage area 532a, 532b may include one or more eNBs and/or HeNBs ((H)eNBs) such as (H)eNBs 538a, 538b. The (H)eNBs 538a, 538b may be associated with or a component of a LTE core network 540 (e.g. that may be similar or the same and/or may include one or more components of one of the core networks 103/104/105 shown in FIGs. 1A and 1C-1E). The (H)eNBs 538a, 538b may have one or more WiFi APs 520a, 520b that may be connected to them (e.g. may be collocated). For example, in an embodiment such as a campus scenario or an apartment, there may be an (H)eNB 538a (or 538b) and a WiFi AP 520a (or 520b) that may connect to it. The AP (e.g. 538a and/or 538b) may be used to offload E-UTRAN based on one or more operator policies.

In an example, when a CS call may be requested, the user may actually be in the same geographical location and may not change cells. For example, a user may be in a campus and a device such as device 500 may be connected to a HeNB such as the HeNB 338a. The user may then request a CS call which may trigger the device 500 to send a CSFB request and that may enable the device 500 to access the CS domain. As shown, the user may be in the same room under both LTE and UTRAN coverage (e.g. coverage areas 530 and 532). The device 500 ay switch back to LTE after the CS call terminates and the user may still be in the same geographical location and under both overlapping E-URAN and UTRAN coverage areas 532, 530 respectively.

As described herein, embodiments may provide a method by which inter-system change (e.g. as part of CSFB) may not cause an impact and/or interruption to an existing PS session for the device 500. In examples, one or more of the following pre-conditions may be set. The eNB and/or HeNB may be connected to and/or collocated with an AP. For example, as shown in FIG. 5, the (H)eNB 538a may be connected to and/or collated with the WiFi AP 520a. Additionally, the device may be in LTE (e.g. may be connected to the LTE core network 540) and may have an active PS session.

For example, the device 500 may receive a request for mobile originating (MO) or mobility terminating (MT) CS voice call. The device 500 may request CSFB for the MO and/or MT CS voice call. In an example (e.g. after the device 500 may request CSFB), the LTE system (e.g. 540) may offload the PS session of the device 500 over the AP 520a. The context of the device 500 (e.g. the UE's or device's context) may remain active in the LTE system 540 (e.g. at a MME, SGW, eNB, and/or the like). The device 500 may send and/or receive PS data over the AP 520a. Additionally, the device 500 may access the CS domain such as GERAN or UTRAN to place the CS call. For example, the device 500 may access the NB 534 and UTRAN core network 536 associated therewith to place a CS call. At this time, a 3GPP RAT may be active at the device 500, for example, at the radio level such that the device 500 may access and may be active with the CS domain. At a NAS level, an EMM NAS entity of LTE and/or a MM NAS entity of GERAN/UTRAN may both active.

In an example, the device 500 may place the CS call with a MSC and/or VLR. The device 500 may not contact a SGSN. As such, the SGSN may be unaware of the device's presence in GERAN/UTRAN. This may happen regardless of a network mode of operation (NMO). For example, even if the network mode of operation may be 1 (e.g. which may use a combined routing and location area updating procedure), the device 500 may override the NMO and may perform a location area updating procedure.

If the device 500 may move away from the AP 520a while the CS call may be active, the device's PS session may be moved to GERAN/UTRAN domain. This may also happen if the device's connection with the AP 520a may deteriorate below a certain acceptable minimum.

Additionally, even if this may be performed or done, there may not be as much delay as there may have been had the device 500 performed an existing CSFB. This may be because the PS session may be resumed in GERAN/UTRAN after the CS call may have been established or terminated. In this example, assuming DTM may be supported, the PS session may directly be moved to GERAN/UTRAN because the CS call may have already been setup.

If the device 500 may not move away from the AP 520a and the CS call may terminate, the device 500 may re-access the E-UTRAN (e.g. via the coverage area 532) and the LTE system 540 may then resume at least a portion of the PS session over E-UTRAN. The system may also continue to offload some traffic over the AP 520a. In an example, “offload during CSFB” (e.g. ODC) may refer to the use of Wifi to offload a PS session during or while performing CSFB/inter-system change as described herein.

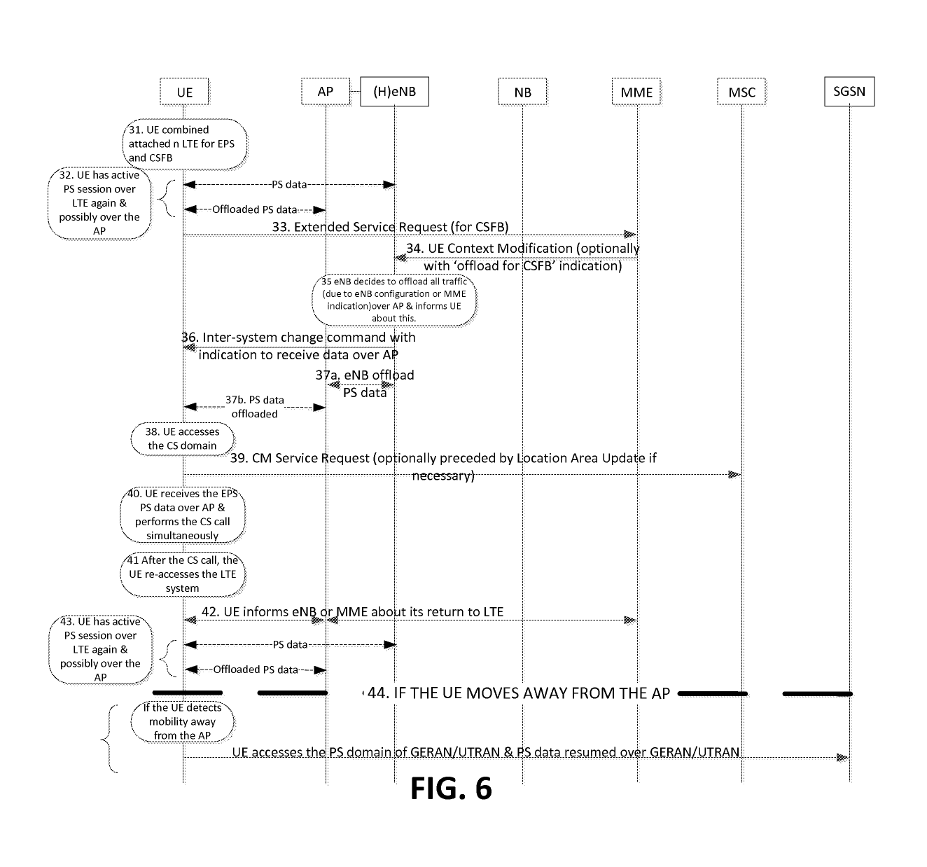

FIG. 6 illustrates an example method that may be used for WiFi offloading during a CSFB. For example, at 31, a device such as the device 500 in FIG. 5 may perform a combined attach for EPS and/or CSFB. In an example, the combined attach may include a combined registration to the PS domain (e.g. in LTE such as LTE 540 in FIG. 5) and CS domain (e.g. via the MSC/VLR) while the device may be in E-UTRAN (e.g. the coverage area 532a, 532b in FIG. 5).

At 32, the device may have an active PS session over LTE (e.g. via (H)eNB 538a in FIG. 5) and/or over WiFi (e.g. via AP 520a in FIG. 5). Via the active PS session, PS data may be exchanged between the (H)eNB and the device and offloaded PS data may be exchanged between the AP and the device.

To trigger CSFB, the device may send an ESR to a MME at 33 (e.g. a MME that may be in the LTE network and may be similar or the same as the example MME 162 described in FIG. 1D) as described herein. The ESR may indicate to the MME to perform CS fallback. The MME may respond to the (H)eNB with a context modification message at 34. The context modification message may include an offload for CSFB indicator or indication. The offload for CSFB indicator of indication may include a value or other indicator that may signal to the (H)eNB to offload or determine whether to offload traffic during CSFB (e.g. because the device 300 may be initiating and/or receiving a voice call).

In an example, at 35, the (H)eNB may determine whether to offload traffic over the AP (e.g. due to the initiation of a voice call such as a CS call). For example, an (H)eNB configuration and/or a MME indication such as the offload for CSFB indication may signal or indicate to the (H)eNB to offload traffic. The (H)eNB may parse the configuration and/or may analyze the MME indication (e.g. in response to the context modification message) to determine whether to offload traffic.

Based on the configuration and/or indication (e.g. if the configuration and/or indication may include a value that may correspond to or indicate to the (H)eNB to offload traffic), the (H)eNB may decide to offload at least a portion of the traffic on the AP and may inform the device of such a decision. For example, at 36, the (H)eNB may provide an inter-system change command to the device. Such a command may indicate to the device that it may receive data over the AP. At 37a, the (H)eNB may then send PS data to the AP which may then send the data onto the device at 37b to offload the data.

At 38, the device may access the CS domain, for example, to initiate and/or receive a CS call. To access the CS domain, in an example, the device may send a CM service request and/or may perform a location area update (e.g. if necessary) at 39. In an example, the device 500 may place the CS call with a MSC and/or VLR. As such, as shown in FIG. 6, the device may not contact a SGSN. As such, the SGSN may be unaware of the device's presence in GERAN/UTRAN. This may happen regardless of a network mode of operation (NMO) as described herein.

At 40, the device may receive the PS data over the AP and may perform the CS call over the GERAN/UTRAN and/or another domain such as E-UTRAN simultaneously. After the CS call may end, the device may reaccess the LTE system and/or another system at 41. The device may inform the (H)eNB and/or the MME that it may have returned to the LTE system and/or to another system at 42. The device may resume an active PS session over LTE and/or over the AP at 43 (e.g. similar to 32).

At 44 (e.g. if the device may move away from the AP while the CS call may be active), the device's PS session may be moved to GERAN/UTRAN domain. This may also happen if the device's connection with the AP may deteriorate below a certain acceptable minimum. For example, if the device may detect mobility away from the AP, the device may access the PS domain of GERAN/UTRAN and/or PS data may be resumed over GERAN/UTRAN.

In examples, one or more of the following may be provided and/or used to perform the example method in FIG. 6 and/or to offload traffic using WiFi for CSFB, for example, with the components of FIG. 5. For example, according to an embodiment, subscription information (e.g. new subscription information) may be defined, for example, in the HSS, for each user such that it may indicate whether or not “offload during CSFB” (ODC) may be allowed. This information may be provided to the MME when the MME may fetch the device's context including following a registration procedure such as an Attach or Tracking Area Update that may trigger the MME to fetch the device's context from the HSS. The MME may further provide this information to the (H)eNB as described herein.

For example, an MME may fetch a device's context from another MME or SGSN. In an example, the contacted MME or SGSN may include such information to the requesting MME. As such, the source MME may have this information even if the HSS may not be contacted in this case. Alternatively, the MME may be configured with such indication as per operator policy. The MME may provide this indication to the (H)eNB that may be serving the device. This may be performed or done in a S1-AP message such as, but not limited to, a UE Context Modification Request.

Additionally, the device may also indicate to the network (e.g. the eNB and/or the MME) that it may be capable to perform ODC. This may be done by including an information element (e.g. new information element) or bit position in the device capability information that may be sent to the eNB/MME. Thus, existing capability indication messages may be extended to carry this new information. Alternatively or additionally, the UE may indicate this to the eNB/MME using any existing or new RRC/NAS messages, respectively.

In an example, as described herein, a WiFi offload may be used (e.g. if possible), for example, for CSFB (e.g. when there may be a request for CSFB). Such CSFB requests may include voice calls, may encompass supplementary and location services of the CS domain, both of which may cause an inter-system change for the UE, and the like. As such, the Wifi offload may be used to maintain a PS session when CSFB/inter-system change may be performed regardless of whether or not a PS service may be supported in the target system. Alternatively or additionally, the WiFi offload may be used if the target system may not support PS HO or if DTM may not be supported by the device or the target network (e.g. GERAN/UTRAN).

As described herein, the device may or may not be attached to the AP before CSFB. To offload, however, the device may attach to the AP. In an example, if the device may not be attached prior to a CSFB, the CS call may trigger the attachment. Further, the device may offload based on one or more preferences (e.g. whether attached before or after the CS call).

As such, one or more device actions before an inter-system change may be provided and/or performed as described herein to support the WiFi offload. For example, one or more of the following may be used and/or performed (e.g. in one or more combinations). In an example, the device may associate with a WiFi AP when (e.g. as soon as) a request for CSFB may have been made by the user, even if no ESR may have been sent to the network. The device may associate with an AP when a request for CSFB may have been received (e.g. there may be a MO request), the device may have received a MT request for CSFB (e.g. via paging or reception of a NAS message), and/or or the UE may have sent an ESR to the MME. The device may associate with an AP if the device may have performed a combined registration to the PS domain (e.g. in LTE) and CS domain (e.g. via the MSC/VLR) while the device may be in E-UTRAN.

Further, the WiFi AP that the device may try to associate for CSFB may be under control of the E-UTRAN network such that the E-UTRAN may offload data through it as described herein. The device may have such information through a pre-configuration, E-UTRAN system information broadcasting, and/or the like. The device may indicate to the network that it may be associated with an AP, for example, when a request for CSFB may be available (e.g. when an ESR may be sent, or before or after an ESR may be sent).

For example, the device may indicate to the MME that it may be associated with an AP. This may be done in a NAS message. This may be done in the Extended Service Request message. For example, in the ESR, an information element may be defined that may be used by the UE to indicate whether or not the UE may be associated with an AP. The UE may also optionally identify (e.g. using a form of an AP identity) the AP with which it may be associated. In an embodiment, these indications from the device may be sent for other reasons and may not be limited to the case of CSFB. As such, the embodiments described herein may also apply to other examples that may not necessarily be for CSFB. For example (e.g. if an ESR may have already been sent), the device may still send another NAS message (e.g. new or existing but modified) to indicate its association with an AP. The details of the AP association such as SSID, BSSID, assigned UE IP address, and/or the like may be also reported to the MME.

The device may further indicate to the eNB that it may be associated with an AP. This may be done as part of the RRC connection establishment procedure. This may also be done after the RRC connection may have been established using an existing or new RRC message. The details of the AP association such as SSID, BSSID, assigned UE IP address, and the like may be also reported to the eNB. Upon reception of this indication (e.g. an association of a UE with an AP), the eNB may inform the MME about this using a S1-AP message (e.g. a new or existing but modified).

The device may also indicate to the MME or eNB whether or not ODC may be desired. This may be done by defining an information element (IE) (e.g. new or existing) in a NAS or RRC message, respectively. In an example, the device may indicate this via each CSFB request and/or may indicate this once for the CSFB requests until a further change may be explicitly signaled by the device to the MME or the eNB.

The device may indicate to the MME that ODC may be provided and/or used in a NAS message such as Attach, TAU, ESR, and/or the like. Also, the device may indicate to the eNB that ODC may be provided and/or used in a RRC message (e.g. existing or new). The device may indicate ODC per a CSFB request in the ESR. The device may also indicate ODC for MO CSFB requests (e.g. only) or for MT CSFB requests (e.g. only). In an example, the device and/or the system may avoid ODC when there may be a CSFB request for emergency voice calls.

According to an embodiment, the device may provide one or more indications described herein based on user interaction and/or settings. For example, the user may (e.g. via a user interface) configure or may enter specific settings to reflect the settings and/or indications herein using the device. The device may request the user to enter his or her desire for ODC for each CSFB call and/or once after registration to the system. The device may be configured with policies to perform ODC (or not) and these policies may be provided via ANDSF, OMA DM, OTA, SMS, and/or the like. In an example, the device may request ODC, for example, if the system may support ODC as described herein via broadcast/dedicated RRC messages and/or NAS messages.

As such, decisions to perform the WiFi offload may be left up to the device similar to decisions on how to return to, for example, LTE being left up to the device. For example, a device local policy that may indicate to attempt to go to GERAN, check in GERAN to see if a PS HO may be supported or not may be provided. In an example, the policy may indicate if a PS HO may not be supported, then the offload should or should not be performed. Further, in an example, the device may indicate that DTM may not be supported and that an offload should be initiated. Such policies may be in configurations in the device as described herein.

In embodiments, the device may request ODC, for example, when it may be associated with a particular AP that may be known to the device or to the user. For example, association with some APs (e.g. an AP at the user's home) may trigger the device to request ODC since the user may be at home and may likely not be leaving. On the other hand, a random AP at campus may not necessarily mean that ODC may be used and user intervention may be requested. As such, the device may be configured (e.g. by the user via the user interface) to request ODC when the device may be associated with a given AP or list of APs. The device may request ODC, for example, when the device may be under a particular CSG cell (e.g. a user's Home eNB) which may have an AP connected to it and the device may be optionally associated with the AP.

The device may inform the eNB whether or not ODC may be desired. The proposals regarding this indication may be sent to the MME as well as the eNB. The device may include this indication in a RRC message or a new RRC message may be defined to do so. The device may send this RRC message after sending the ESR or may include this in the message that may carry the ESR NAS message.

Additionally, the device may be configured with the list of APs via which ODC may be supported. Thus, in an example (e.g. if the device may be connected to one or more of these APs), the UE may assume ODC support and may hence request ODC. Furthermore, the UE may include a list of eNB IDs such as CSG IDs that may support ODC. As such, if the UE may be served by these eNBs, the UE may assume ODC support and may hence request ODC as described above.

One or more actions for the MME may be provided and/or used in WiFi offloading for CSFB as described herein. For example, one or more of the following actions may be taken by the MME (e.g. in various combinations and orders). In an embodiment, some of these actions may be taken after the eNB may inform the MME about certain events and/or decisions as described herein.

For example, the MME may indicate to the UE whether or not ODC may be supported by the system. This may be done by including a new IE in a NAS message. The MME may inform the eNB that the UE may be allowed to have ODC when a CSFB request may be pending. This may be done by including a new IE in the UE Context Modification Request message that may be sent by the MME to the eNB. This message may typically include a “CSFBIndicator” IE and hence the MME may include the proposed new indication with the existing IE.

The MME may send this indication or set its value to reflect “ODC allowed” or “ODC not allowed” based on operator policy, UE subscription information, UE capability and whether or not the eNB may connect to an AP or whether the system may perform Wifi offload. The MME may also decide to perform ODC if the UE may already have user data bearers setup when the CSFB request may be performed.

The MME may decide to use ODC as per indication from the UE. For example, as proposed above, the UE may indicate in the ESR that ODC is required. On the other hand, if the UE indicates that ODC is not required, then the MME may decide not to perform ODC.

Thus, the MME may have received an indication from the UE that it is associated to an AP, or the MME may have received an indication from the eNB that Wifi offload is supported (as is proposed in the sections that follow); and based on at least one of these indications, the MME may decide to use ODC for the UE and hence may include this indication to the eNB. The eNB may then perform ODC for the UE when CSFB may be realized. According to an embodiment, the MME may also provide the eNB with the AP identity that the UE may have been associated with.

In the embodiments described herein, the MME may make a decision to perform ODC (e.g. based on at least one of factors described herein) and/or may inform the eNB whether or not ODC may be performed in an S1-AP message such as the UE Context Modification Request. The MME may use an IE or bit (e.g. a new IE or bit) to indicate “ODC” or “no ODC” during a CSFB request. The MME may inform the eNB that ODC may be allowed for the UE and may leave it up to the eNB to decide whether or not ODC may be used. The eNB may then inform the MME about its decision for each CSFB request.

The MME may also inform an SGSN (e.g. one or more of the SGSNs that may connect with the MME) that the device may be having an ODC service while performing CSFB. This may be done as a result of the UE performing a routing area updating (RAU) procedure if the PS session may be transferred to GERAN/UTRAN. In an example, the SGSN may use this indication to take other actions. For example, the SGSN may fetch the device's context without waiting for the device to perform a RAU. Further, the MME may forward the device's context directly to the SGSNs that may connect to it even if the device may not perform a RAU with the SGSNs. The MME may take this action for reasons different from CSFB (e.g. it may do so to speed up a handover procedure that may be pending). The MME may inform the SGSN, for example, when a decision may have been made to perform ODC or when the eNB may inform the MME that ODC may be active (e.g. as described herein). For example, in a HO, the MME may go to GERAN to see whether the HO supported transfer over to SGSN. However, in an example, if data may be resumed over WiFi, a context transfer to SGSN may not be performed and/or the MME may signal to SGSN offloading to inform the SGSN offloading over GERAN may not be performed.

In an example, the device may perform a RAU (e.g. whenever possible after the inter-system change) and may then indicate to the SGSN that ODC may be active. This may enable the SGSN to fetch the UE's context from the MME, but the SGSN may not take any action to transfer the PS session under its control. Thus, when fetching the context from the MME, the MME may indicate whether ODC may be active or not. The SGSN may later transfer the session under its control after a device or MME may indicate to do so.

For ODC (e.g. after the MME may decide to perform ODC and hence informs the eNB, or after receiving an indication from the eNB that ODC may be active as described herein), the MME may maintain the device's context even if the device may not be active in E-UTRA (e.g. the device's E-UTRA radio may be off).

The MME may define and may use a flag that may indicate whether or not the UE may be having ODC. As such, upon the use of ODC, the MME may set the flag to a value that may indicate, as an example, “ODC active.” Moreover (e.g. after the return of the device to the LTE system), the MME may set the flag to “ODC inactive.” However (e.g. if the device may not return to LTE), the MME may take actions that may exist currently (e.g. may consider the device to no longer be EMM-CONNECTED).

While the device may access the CS domain and the LTE system may decide to perform ODC, the MME may maintain the device's context as being in connected mode even though the device may not have a NAS signaling connection with the MME and vice versa. The MME may maintain the device's user plane active until it may be decided that the device may be resuming the PS session in GERAN/UTRAN. Additionally, while the device may be in GERAN/UTRAN with ODC active, the MME may reject a PDN GW initiated request for session management such as modification or activation of a new bearer

In an example, the MME may accept these requests and modify the S1 bearers accordingly. For example, the MME may inform the device upon its return to LTE to modify the corresponding EPS NAS bearer contexts and radio resources in the device. The MME may also inform the eNB about this such that the eNB may reconfigure the device's radio bearers accordingly, for example, after the device may return to LTE. Further (e.g. when the S1 bearers may be modified for a device with ODC active), the eNB may save these changes and/or may reconfigure the device's bearers accordingly, for example, when the eNB may detect that the device may have returned to the same cell. As such, both the MME and the eNB may delay the corresponding signaling with the device until its return to the LTE system after which the MME and/or the eNB may execute the desired signaling even though changes may have already been made to the bearers on the network side.

Additionally, one or more eNB actions may be provided and/or used in WiFi offloading for CSFB as described herein. For example, one or more of the following actions may be taken by the eNB (e.g. in one or more combinations or orders). The eNB may broadcast the support of ODC. Optionally, the eNB may broadcast the support of ODC for a specific AP (e.g. when the UE may be associated with a specific AP).

According to embodiments, the eNB may decide to perform ODC using one or more of the following (e.g. in various combinations or orders). For example, the eNB may decide to do ODC for each CSFB. Optionally, the eNB may decide to do ODC if the eNB may connect to an AP with which the UE may have been associated. As such, the eNB may use indications from the UE about its association with an AP (e.g. as described herein) to perform ODC. The eNB may further decide to do ODC as per request or indication from the MME (e.g. using the proposals described herein). The eNB may also decide to do ODC as per request from the UE (e.g. as described herein) and the eNB may decide to do ODC as based on an indication from the device that ODC may be supported by the device.

In an embodiment, the eNB may inform the MME that the device may be associated with an AP. This may be done during CSFB procedure or using a NAS message that the eNB may send over an interface such as a S1 interface to the MME. For example, the indication may be included in a S1-AP message as an IE.

The eNB may further decide to do ODC based on a WiFi measurement report from the device. For example, in an embodiment, if a WiFi signal strength (e.g. RSSI) may be better or greater than a certain threshold, the eNB may perform ODC.

The eNB may also be configured with information about neighboring cells and whether or not PS HO (or DTM) may be supported in these cells. As such (e.g. after a cell may be chosen as a target cell), the eNB may decide whether to perform ODC or not based on PS HO support and/or DTM support of the target cell. For example, if due to measurements or other local configuration, the eNB may have chosen to redirect the device to a cell where the core network may not support PS HO and/or DTM may not be supported, the eNB may choose to perform ODC. In an example, the device may inform the eNB (and/or the MME) whether the device may support DTM. As such, according to an embodiment, the eNB may choose to use ODC if, for example, DTM may not be supported by the device. The MME may provide this information (e.g. if received from the device) to the eNB via a S1AP message.

In an example, the eNB may perform ODC where there may be a decision to not perform a PS HO as part of CSFB. As such, each time the eNB may decide to perform a cell change order or RRC release with redirection (e.g. optionally with support of target system information in the release message), the eNB may decide to perform ODC, for example, if the device may be associated with an AP or may associate with an AP that may be connected with the eNB.

Additionally, a S1-AP procedure and/or message may be provided and/or defined that may be used by the eNB to inform the MME whether or not ODC may be performed. For example, an existing S1-AP message may be used and modified to include this indication to the MME and/or a new S1-AP procedure and/or message may be defined. For example, in an embodiment, the eNB may make decision by itself to offload and/or may inform the MME offload for the device. The MME may be told to maintain context by the eNB. The eNB may, in an example, keep context of the device and LTE such that when it may go back to LTE (e.g. the CS call may end), it may resume without having to set up the device, eNB, and/or the like from scratch.

The eNB may send this message whenever a decision may have been made to perform ODC. As such, the message may indicate, as an example, “ODC active” or “ODC not active.” The eNB may include a cause code to indicate the reason why the decision may have been taken. For example, the eNB may indicate “ODC not active” and may include a cause code that may indicate the reason including either an error in the AP or UE measurements not being favorable for Wifi offload, and the like.

After deciding to perform ODC, the eNB may send an inter-system change command and/or message to the device and may include an indication that ODC may be performed. The inter-system change command and/or message may be an RRC Connection Release message that may include an IE (e.g. a new defined IE) to indicate ODC. The IE may have a value that indicates “CSFB with Wifi offload” or “CSFB without Wifi offload” as an example. As such, if the IE may indicate ODC, the device may understand that WiFi offload may be fully active and the device's PS data may be transferred to LTE and the device may not access the PS domain of the target system (e.g. with certain exceptions as described herein). If the eNB may indicate no ODC, the device may perform the existing procedures for CSFB when it may access the target system.

In an example, the inter-system change message may be the existing handover command such as a MobilityFromE-UTRACommand. However the UE may not perform (or may refrain from performing) signaling towards the SGSN (e.g. regardless of the network mode of operation) if informed about ODC being active.

Additionally, the eNB may include an identity of the AP that may be used for ODC. This may be based on an AP that may be already being used to offload, for example, prior to the request for CSFB. In an example, the chosen AP may be recommended by the MME or the device, for example, due to or in response to measurements that may have reported by the device.

In embodiments, the eNB may maintain the device context while the device may be in GERAN/UTRAN and ODC may be active. The eNB may maintain the security parameters that may have been used before ODC and may use the same parameters after the device may return. In addition, the eNB may maintain the device's assigned C-RNTI for use, for example, when the device may return to LTE. The eNB may maintain its tunnel connections with the SGW for the user plane. For example, the eNB may maintain the S1 bearers for the device. Also, the eNB may maintain the S1 control plane connection and/or context with the MME for the device.

The eNB may define and maintain a flag that may indicate whether or not the device may be provide and/or use ODC. As such, when the eNB may inform the device to perform inter-system change and may use ODC, the eNB may set the flag to a value that may indicate the use of ODC. In an example, after the device's return or after termination of ODC, the eNB may change the value of this flag to indicate otherwise.

One or more actions for a UE to perform inter-system change with ODC activated may be provided and/or used as described herein. For example, the device may verify GERAN works when DTM may not supported, for example, if the device may start a CS call, it may wait until the CS call terminates and then may resume the suspended PS call when WiFi offloading may not be supported. In WiFi offloading, even if a CS call may be finished, the SGSN may not be contacted, because offloading over WiFi may already be provided (e.g. before the CS call) and the device may be aware of the WiFi, for example.

For example, upon the reception of an indication (e.g. optionally from the eNB) to perform inter-system change with Wifi offload (e.g. via an ODC indication), the device may take one or more of the following actions (e.g. in one or more combinations or orders). The device may consider itself to still be EMM-CONNECTED and the device may define and use a flag that may indicate whether it may be in ODC operation or not. As such, the device may set the value to indicate that ODC may be active. In an example, the device may not send further EMM/ESM requests based on this indication even if the higher layers request it. In an embodiment, for a pending ESM/EMM request, the device may verify the value of ODC. If it may indicate, for example, “ODC active” the device may not send the NAS message until the device may return to LTE and/or the flag may indicate “ODC inactive.”

The device may access the CS domain/RAT and/or may continue with the appropriate MM procedure to get the CS service that prompted the inter-system change. After the MM procedure may be complete, the device may refrain from sending a GMM message to the SGSN because ODC may be active. Thus, the device may refrain from sending a RAU while ODC may be active.

In an example, the device may maintain the RRC configuration and may start receiving and sending PS data over WiFi as indicated by the eNB. The device may already be associated to an AP and may start the offload over WiFi directly.

If the device may not be associated to an AP, the device may associate to an AP that may be indicated by the eNB. The device may start to use the AP to send and/or receive data. During the time of association, the device may not send a GMM message to the SGSN. Alternatively or additionally, the device may have a timer that may guard the association with the AP. If the association with the AP may fail after the timer expires (e.g. or after a well known or configured time), the device may access the PS domain of GERAN/UTRAN and/or may send a GMM message.

A PS session may also be resumed in LTE after CSFB (e.g. with WiFi offloading) using one or more of the following (e.g. in one or more combinations or orders). For example, after the device may terminate its CS service, the device may perform the random access (RACH) procedure. However, the device may not send a NAS in the last part of the RACH procedure. In an example, the UE may send a NAS message in the RRCConnectionSetupComplete message.

In an embodiment, the device may indicate in a message of the RACH procedure that it may be a device that may be returning from CSFB and may have ODC active. The device may indicate its previously assigned C-RNTI such that the eNB may keep using this identity to serve the device.

The device may further perform a tracking area update and may optionally indicate its return from CSFB using a new IE in the NAS message. In an example, the device may indicate in the TAU message that ODC may be active. This may trigger the network (e.g. the MME) to stop or modify ODC.

After the reception of an indication of the UEs return, the eNB and/or the MME may decide to stop ODC or may decide to resume some of the data packets over E-UTRA. The MME may send a S1-AP message to the eNB indicating the stop of ODC. In an example, this may happen after the MME may receive a NAS message (e.g. TAU) from the device that may indicate the device may have returned to LTE and/or that the device may want to stop ODC. Additionally, the eNB may decide to stop ODC either as per local policy and/or configuration and/or as per indication from the UE or as per request from the MME.

The MME and/or the eNB may also perform signaling related to modifications of existing bearers that may have been triggered by the PDN GW during the absence of the device from LTE (e.g. as described above). Additionally, stopping ODC may not result in the use of WiFi offload being completely stopped. Rather, the LTE radio may be used for traffic and the eNB may use the LTE radio to forward and/or receive traffic to and/or from the UE.

In examples, ODC may be stopped and/or a PS Session in GERAN/UTRAN may be resumed using one or more of the following (e.g. in one or more combinations and/or orders). For example, the device may send a NAS message to the SGSN, for example, via a routing area update (RAU) message and/or the device may indicate that ODC may have been active. The device may further indicate its desire to stop ODC.

The SGSN may resume the session over GERAN/UTRAN (e.g. after a RAU may be received from the device). The SGSN may have already fetched the device's context in one example. The SGSN may inform the MME that the session may be resumed over GERAN/UTRAN.

According to an example, the user may request, via a user interface, that ODC may be stopped. This may trigger the device to send a NAS message to the SGSN, for example, via a RAU or Suspend. The device may send a NAS message to the SGSN, for example, via a RAU after a certain time elapses. The device may be configured with a maximum time during which ODC may be permissible.

The device may send a NAS message to the SGSN, for example, via a RAU, to stop ODC if the device may observe a degradation in the QoS of the PS session that may be offloaded over WiFi. The device may send a NAS message to the SGSN, for example, via a RAU, to stop ODC if the device's connection with the WiFi AP may be lost and/or if the signal strength received from the WiFi AP may fall below a certain minimum.

The device may suspend the session in the target domain if this may not already be done. For example, if connection with the AP may fail or if the signal strength may fall below a certain threshold, the device may send a NAS message to the SGSN where the NAS message may be a message such as Suspend (e.g. if this may not have already been done) or RAU. The device may indicate if ODC may be active in one or more the NAS messages that it may send to the SGSN. If requested to resume a session, the SGSN may inform the MME to resume the session in GERAN/UTRAN.

In an example, the device may send a NAS message to the SGSN, for example, via a RAU, to stop ODC. For example, the ODC may be stopped if no user plane data may be received over the WiFi, for a configurable or known time, even if the device may still have a connection with the AP. In particular, a timer may be provided such that upon WiFi offloading may be stopped after the timer may elapse. In such an example, the PS session may return to LTE and/or another network.

The device may indicate to the WiFi AP to stop offload. This may result in modifications to the WiFi messages such as MAC messages to implement such a capability. The device may send a control message to the eNB via the WiFi AP. As such, the device may send 3GPP messages over WiFi and the WiFi AP may forward the message to the eNB. The device may further indicate to stop ODC and/or the eNB may do so. The WiFi AP may, for example, after loss of connection with the device, indicate to the eNB that connection with the device that may have been lost. This may trigger the eNB to stop ODC.

According to an example, a message may be defined between the eNB and the MME which may allow the eNB, to inform the MME that ODC may have been stopped. This may be due to a request from the device as described herein (e.g. above) or may be due to an indication from the WiFi AP that connection with the UE may have been lost.

Upon reception of an indication and/or request to stop ODC, the MME may inform the SGW to suspend the PS session and/or buffer the data packets for the device in question. The SGW may, in turn, request the PGW to suspend and/or buffer the packets for the device in question. The eNB may optionally forward packets back to the SGW for buffering if connection with the device may have been lost and some packets may not have yet been transmitted to the device.

In an example, the MME may receive a request to resume a packet service over GERAN/UTRAN while ODC may be active. When this may occur or due to or in response to other reasons or factors that may make the MME decide to stop ODC, the MME may inform the eNB to stop ODC. This may be done using a S1-AP message (e.g. new or existing but modified). Thus, a new S1AP message or modification to an existing S1AP message may be provided and/or used by the MME to inform the eNB to stop or start or suspend and/or resume ODC. Additionally, after a reception of a request to stop ODC, the eNB may release the device's context as if an RRC connection release procedure may have been executed.

Although the terms UE or WTRU may be used herein, it may and should be understood that the use of such terms may be used interchangeably and, as such, may not be distinguishable.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) for providing packet-switched (PS) services during a circuit-switched callback (CSFB), the WTRU comprising a processor configured to:
during a CSFB to GERAN with no DTM or PS handover (PS HO) support in a network:
offload traffic for a PS session to a WiFi connection during a CS voice call over the network such that the PS session is maintained on WiFi during the CS voice call over the network.

2. The WTRU of claim 1, wherein the processor is further configured to stop offloading the PS session on the WiFi connection after an expiration of a timer.

3. The WTRU of claim 1, wherein at least a portion of the traffic for a PS session remains offloaded to the WiFi connection after the CS voice call ends.

4. The WTRU of claim 1, wherein the processor is further configured to receive an indication to offload the traffic for the PS session to the WiFi connection; and

[symbol]

5. The WTRU of claim 1, wherein the indication is in response to the CS voice call.

6. The WTRU of claim 1, wherein the indication is in response an extended service request (ESR).

7. The WTRU of claim 1, wherein the PS session is further configured to be offloaded to another network when signal strength with the WiFi degrades below a threshold.

8. The WTRU of claim 1, wherein an active NAS context for the PS session is maintained in the network during the offload.

9. A wireless transmit/receive unit (WTRU) for providing packet-switched (PS) services during a circuit-switched callback (CSFB), the WTRU comprising a processor configured to:
during a CSFB to GERAN with no DTM or PS handover (PS HO) support in a network:
offload traffic for a PS session to a WiFi connection during a CS voice call over the network such that the PS session is maintained on WiFi during the CS voice call over the network; and
stop offloading the PS session on the WiFi connection after an expiration of a timer.

10. The WTRU of claim 9, wherein the processor is further configured to receive an indication to offload the traffic for the PS session to the WiFi connection; and
z,999

11. The WTRU of claim 9, wherein the indication is in response to the CS voice call.

12. The WTRU of claim 9, wherein the indication is in response an extended service request (ESR).

13. The WTRU of claim 9, wherein the PS session is further configured to be offloaded to another network when signal strength with the WiFi degrades below a threshold.

14. The WTRU of claim 9, wherein an active NAS context for the PS session is maintained in the network during the offload.

15. A wireless transmit/receive unit (WTRU) for providing packet-switched (PS) services during a circuit-switched callback (CSFB), the WTRU comprising a processor configured to:
establish a PS session in a network;
receive an indication to offload traffic for the PS session to a WiFi connection; and
offload traffic for the PS session to the WiFi connection during a CS voice call over the network such that the PS session is at least simultaneously maintained on WiFi during the CS voice call over the network.

16. The WTRU of claim 15, wherein an active NAS context for the PS session is maintained in the network during the offload.

17. The WTRU of claim 15, wherein the indication is in response to the CS voice call.

18. The WTRU of claim 15, wherein the indication is in response an extended service request (ESR).

19. The WTRU of claim 15, wherein the PS session is further configured to be offloaded to another network when signal strength with the WiFi degrades below a threshold.

20. The WTRU of claim 15, wherein the processor is further configured to stop offloading the PS session on the WiFi connection after an expiration of a timer.
